(19) United States
(12) Patent Application Publication
(10) Pub. No.: US 2024/0007233 A1
(43) Pub. Date: Jan. 4, 2024

(54) Edge Device and Method for Providing Redundancy Functions on the Edge Device

(71) Applicant: Siemens Aktiengesellschaft, Muenchen (DE)

(72) Inventor: Sven GOTTWALD, Nürnberg (DE)

(21) Appl. No.: 18/038,105

(22) PCT Filed: Nov. 18, 2021
(86) PCT No.: PCT/EP2021/082149

§ 371 Date: May 22, 2023

(30) Foreign Application Priority Data
Nov. 25, 2020 (EP) 20209780.4

(51) Int. Cl. H04L 1/22; H04L 45/28; H04L 12/437; H04L 12/40; G05B 19/042

(52) U.S. Cl. CPC H04L 1/22; H04L 45/28; H04L 12/437; H04L 12/40176; G05B 19/042; H04L 2012/4026; G05B 2219/24192; G05B 2219/39169; G05B 2219/33235

(57) ABSTRACT

An edge device includes a first communications connection to a public first network, a plurality of second communications connections to a second network, i.e., a private industrial network, and application software that is loadable via the first connection into the edge device, wherein the edge device is configured such that the plurality of second communications connections are configurable via the application software for redundant operation of the second network in accordance with an industrial redundancy protocol, and the application software executes redundancy functions of the redundancy protocol, such that a quick and simple way of providing, changing or retrofitting redundancy functions for a redundantly operated industrial communications network is hereby possible.

### CROSS-REFERENCE TO RELATED APPLICATIONS

This is a U.S. national stage of application No. PCT/EP2021/082149 filed 18 Nov. 2021. Priority is claimed on European Application No. 20209780.4 filed 25 Nov. 2020, the content of which is incorporated herein by reference in its entirety.

### BACKGROUND OF THE INVENTION

### 1. Field of the Invention

The invention relates to an edge device, an application and a method for providing redundancy functions on the edge device.

### 2. Description of the Related Art

An industrial automation system typically comprises a plurality of industrial automation devices that are interconnected via an industrial communication network and are used to control or regulate plant, machinery or devices as part of manufacturing or process automation. Because of time-critical requirements in technical systems that are automated via industrial automation devices, real-time communication protocols, such as PROFINET, PROFIBUS, Real-Time Ethernet or Time-Sensitive Networking (TSN), are predominantly used for communication between automation devices in industrial communication networks.

Interruptions in communication links between computer units of an industrial automation system or industrial automation devices are extremely problematic, because this can result in information loss and consequently plant, machine or device malfunction. These interruptions can also result, for example, in undesirable or unnecessary repetition of transmission of a service request. This places an additional load on communication links of the industrial automation system, which can lead to further system malfunctions or faults. In addition, messages that are not transmitted or not completely transmitted may, for example, prevent an industrial automation system from transitioning to or remaining in a safe operating state. In the worst case, this can result in failure of an entire production system and costly production downtime. A particular problem in industrial automation systems regularly results from message traffic with relatively many but relatively short messages, thereby exacerbating the above issues.

In order to be able to compensate for failures of communication links or devices, communication protocols, such as Media Redundancy Protocol, High-availability Seamless Redundancy, Parallel Redundancy Protocol or (Rapid) Spanning Tree Protocol, have been developed for high-availability, redundantly operable industrial communication networks.

Media Redundancy Protocol (MRP) is defined in the International Electrotechnical Commission (IEC) 62439-2 standard and enables individual link failures in networks to be compensated with redundant transmission of messages. Here, the network comprises a plurality of communication devices connected within a ring topology, where each device comprises two ports for connecting the device to the ring topology. One communication device of the communication devices is configured as a “ring redundancy manager” within the ring topology. The other communication devices are referred to as “ring clients”. The ring redundancy manager monitors the ring topology for interruptions using transmitted test messages and controls forwarding of messages containing payload data between its two ports if an interruption is detected.

High-availability Seamless Redundancy (HSR) and Parallel Redundancy Protocol (PRP) are defined in the IEC 62439-3 standard and provide bumpless redundant transmission of messages, in particular with a smooth transition in the event of topology changes. According to the High-availability Seamless Redundancy and Parallel Redundancy Protocol, each message from a sending communication device is duplicated and sent on two different paths over a network to a receiver. Redundant messages constituting duplicates are filtered out of a received data stream by a receiver-end communication device.

In a redundant HSR or PRP communication network, a network component that provides access to the redundant communication network can assume different roles. An HSR/PRP-capable network component in its simplest form is termed a Double Attached Node (DAN). A network component that conveys datagrams between users or terminals in an HSR or PRP communication network, on the one hand, and terminals or network segments without HSR/PRP functionality, on the other, is referred to as an HSR/PRP proxy or RedBox. In principle, a network component can also connect a plurality of HSR rings or implement communications between HSR and PRP network segments for access to a redundant HSR or PRP communication network. Here, the network component is referred to as an HSR-HSR coupler or QuadBox or HSR-PRP coupler.

In the network components, i.e., communication devices, the redundancy functions (for example, MRP ring redundancy manager function, HSR duplicate filtering function) are usually implemented by a field-programmable gate array (FPGA) (see, for example, EP 2 838 220 A1), i.e., in firmware. They are therefore closely linked to the hardware of the device. Subsequent modification or retrofitting of such redundancy functions in a device therefore involves significant outlay, if it is possible at all.

WO 2016/097459 A1 discloses in FIG. 4 a PRP Transition Unit (for example, a RedBox) having a communication port to a first conventional network (for example, an office network of a plant, but not directly to the Internet), a first PRP communication port to a Layer 3 switch of a first PRP network, and having a second PRP communication port to a Layer 3 switch of a second PRP network. The PRP Transition Unit provides redundancy functions of the PRP redundancy protocol. More specific details about the design of the PRP transition unit are not disclosed. For the PRP Transition Unit, reference is made by way of example to the RSP Switch Hirschmann RSP 25 by Belden Inc., in which it is possible to update the operating software via an SD card (see Hirschmann, user manual, Installation Industrial Ethernet Rail Switch Power, RSP20/25/30/35, Release 16, December 2019, Page 30).

EP 2 784 988 A1 discloses, in FIG. 1, a modular control device having a plurality of ports for a fieldbus communication link to automation devices, and ports for an industrial communication network comprising two sub-networks. The modular control device can be connected to a control system via the industrial communication network. The modular control device comprises an interface module with a signal processing unit which is preferably implemented via an FPGA. The signal processing unit provides redundancy functions of a bumpy redundancy protocol (for example, MRP) as well as redundancy functions of a bumpless redundancy protocol (for example, HSR or PRP), where selective switching between these protocols is possible.

U.S. Pat. No. 9,407,582 B2 discloses a communication device having a connection to a Supervisory Control and Data Acquisition (SCADA) system and having connections to two redundant PRP sub-networks. The communication device comprises a signal processing unit implemented via an FPGA. The signal processing unit provides redundancy functions of the PRP redundancy protocol for the PRP sub-networks. In principle, communication using the HSR redundancy protocol is also possible.

### SUMMARY OF THE INVENTION

Proceeding from the foregoing, it is an object of the present invention to provide a device that provides a fast and low-outlay way of providing, modifying or retrofitting redundancy functions for a redundantly operated industrial communication network.

This and other objects and advantages are achieved in accordance with the invention by an edge device, application software and a method for providing redundancy functions in accordance with an industrial redundancy protocol on the edge device.

The invention is based on the insight that edge devices can be extremely advantageously used for flexibly providing redundancy functions. Industrial automation systems or industrial communication networks are usually operated in data “islanded” mode, i.e., as a private network that is separated from public networks, in particular the Internet. This serves, for example, to prevent data-related attacks on the automation system. However, it is increasingly recognized that there is great benefit in being able to exchange data with a public network, in particular a data cloud (also referred to as a “cloud” in the following). There are many reasons for this. For example, it would enable different local automation systems to be networked with each other, production operations to be controlled from different locations around the world, orders to be transmitted to the automation arrangements and production data to be read.

In order to regulate and control the exchange of data between the private networks of the automation arrangements and the public network, in particular the cloud, edge devices are used at the boundary between the private and the public network.

The edge device in accordance with the invention comprises a first communication port to a first network, in particular a public network, and at least two second communication ports to a second network, in particular a private industrial network.

In accordance with the invention, the edge device comprises application software that can be loaded into the edge device via the first communication port. The edge device is configured such that the application software can be used to configure the second communication ports for redundant operation of the second network in accordance with a redundancy protocol, where the application software is configured to perform redundancy functions of the redundancy protocol.

The provision of the redundancy functions in accordance with the invention is thus purely software-based and therefore independent of the hardware of the edge device. The application software and hence the redundancy functions are provided via the first communication port. Consequently, this can also occur subsequently to the actual manufacture of the edge device. Overall, this means that the redundancy functions can be provided, modified or retrofitted quickly and with low outlay. Advantageously, edge devices without any relationship to the second network can also receive the redundancy functions and thus be used for redundant operation of the second network.

The main function of the edge device can be implemented, for example, as a gateway to a cloud, a switch, an I/O station or a programmable logic controller (PLC). If the edge device has the appropriate data capability, then it can also run applications and processes that cannot be executed on programmable logic controllers, for example. These include complex calculations, evaluations of production data, archiving tasks and the like.

For this purpose, the edge device in accordance with the invention is configured to receive the application software via the first communication port and to execute it thereafter.

It is particularly advantageous if the redundancy functions can be performed without needing to load further software components, i.e., operating system software, drivers, IP stack or the like, into the edge device in addition to the application software. This is different from firmware, for example, which typically includes further software components of this kind.

The edge device can also have special installation software for this purpose, which implements storage of the application software in a memory of the edge device and any necessary configuring of the application software.

Configuration of the second communication ports is necessary, for example, in order to:
assign the second communication ports to a real or virtual communication network (for example, interconnection or linking of second communication ports for a ring functionality),
activate a blocking function for datagrams (for example, in the case of an MRP master) or a forwarding function for datagrams (for example, in the case of an MRP client) for a second communication port, depending on the role of the edge device in the redundancy protocol,
activate or deactivate monitoring of the connection status of second communication ports, for example, link-up monitoring or link-down monitoring,
in principle enable or disable a second communication port (for example, activate or deactivate a “Link active”).

For this purpose, the edge device can comprise a memory unit for non-volatile storage of application software program code, a processor for processing the program code, and a main memory into which the program code can be loaded for the execution thereof. With the memory unit, the main memory, the processor, and an operating system installed in the edge device, a sequential control environment for the application software can then also be implemented.

The second communication ports are preferably connected to a data bus formed in particular as a backplane switch, where the data bus is configured such that interconnection of the second communication ports on the data bus can be configured via the application software.

For example, the edge device or data bus can have one or more registers (i.e., data stores) that define the interconnection (i.e., linking) of second communication ports, and the application software has write access to these registers in order to define the interconnection of the second communication ports.

In principle, the invention can be used for a number of redundancy protocols for high-availability, redundantly operable industrial communication networks.

In accordance with an advantageous embodiment, the redundancy protocol is the Media Redundancy Protocol (MRP) per IEC 62439-2.

The application software can then advantageously be established such that it can perform, in particular selectively, a ring redundancy manager or a ring redundancy client function. Thus, an edge device can be flexibly upgraded to a ring redundancy manager or ring redundancy client as per the MRP protocol. The application software can advantageously perform both a ring redundancy manager function and a ring redundancy client function, and the application software provides a user interface for selecting one of the two functions for the performance thereof.

In accordance with another advantageous embodiment, the redundancy protocol is the High-availability Seamless Redundancy Protocol (HSR) or the Parallel Redundancy Protocol (PRP) per IEC 62439-3.

The application software can then advantageously be established such that it can be used, in particular selectively, to perform a Double Attached Node (DAN), RedBox or QuadBox function per IEC 62439-3.

Thus, an edge device can be flexibly upgraded to a Double Attached Node (DAN), RedBox or QuadBox in accordance with the HSR or PRP protocol. Advantageously, both a Double Attached Node (DAN), RedBox and QuadBox function can be performed by the application software, and the application software provides a user interface for selecting one of the three functions for the execution thereof.

In accordance with the invention, the application software provides a user interface for logically assigning second communication ports, i.e., in order to allocate selected second communication ports exclusively and to interlink them in a switched manner for forwarding datagrams. The user interface can also provide options for selecting or parameterizing redundancy functions.

To avoid malfunctions from the outset, the application software in accordance with the invention provides a test function to check the suitability of the edge device to perform the redundancy functions of the redundancy protocol. For example, this test function can be performed during an initialization process of the application software. The test function can be used to interrogate the edge device hardware about the number of available second communication ports of the edge device. For example, if at least two second communication ports are not available, then the edge device will not be suitable to perform the redundancy functions. Such an interrogation can be performed by the application software, for example, by reading registers of the edge device hardware (for example, a data bus to which the second communication ports are connected).

In accordance with another advantageous embodiment, the edge device comprises a sequential control environment configured to execute on a host operating system installed in the edge device, where the application software can be loaded into the sequential control environment for execution there, and where the sequential control environment comprises an interface for accessing the second communication ports.

The application software can then comprise one or more software containers established to execute in isolation from other software containers or container groups within the sequential control environment on the host operating system.

In the sequential control environment or in further sequential control environments, different application software can then be executed in isolation and independently of one another in order to implement different functionalities of the edge device.

In principle, alternative micro-virtualization concepts, such as snaps, can also be used for the application software. Accordingly, the sequential control environment can comprise a Docker engine or a Snap Core running in the edge device.

The sequential control environment advantageously comprises a software component which, as a kind of an adapter between the application software and the hardware, directly accesses the second ports and provides hardware resources (e.g., buffer memory, and/or interrupt line to the CPU) of the edge device that are required to perform the redundancy functions. This ensures good interaction between the application software and the edge device hardware.

This (adapter) software component is advantageously established to filter and evaluate datagrams received via the second ports according to the redundancy functions specified by the application software. This enables the (adapter) software component to ensure, for example, when the edge device is operating as an MRP redundancy manager, that the ring is in working order and to perform ring failover in the event of a fault.

The objects and advantages are achieved in accordance with the invention by a method for providing redundancy functions according to an industrial redundancy protocol on an edge device comprising a first communication port to a first network, in particular a public network, and at least two second communication ports to a second network, in particular a private industrial network, where the method comprises a) loading application software onto the edge device via the first communication port, b) configuring the second communication ports via the application software for redundant operation of the second network in accordance with a redundancy protocol, and c) performing redundancy functions of the redundancy protocol by the application software.

In accordance with the invention, step b) comprises:
performing a check, via the application software, to determine whether hardware of the edge device is suitable to perform the redundancy functions, in particular check for the presence of a required number of second communication ports,
if the check is unsuccessful: terminate the method,
if the check is successful: continue the method by:
requesting the provision of information about the configuration of the second communication ports, in particular about their (logical) interconnection, and/or on the selection of redundancy functions,
acquiring information about the configuration of the second communication ports, in particular about their (logical) interconnection, and/or about the selection of redundancy functions,
configuring the second communication ports, in particular (logically) interconnecting the second ports, and/or setting the selected redundancy functions in the application software, in particular depending on the acquired information about the configuration,
physically connecting the second network to the second communication ports.

Application software in accordance with the invention is established such that, in an edge device as described above, it can be loaded into the edge device via the first communication port and can be executed there, where it comprises commands that cause the edge device to perform steps b) and c) of the method in accordance with the invention.

The application software must be of a dimension, for example, with respect to the amount of data or file size, such that it can be received by an edge device via its first communication port and stored in a memory of the edge device. In addition, it must be established, for example, such that it can be executed on an operating system or execution environment of the edge device. If, for example, a Docker engine is used as the execution environment, then the application software must be in the form of a container for the Docker engine. In addition, the application software must, for example, be established such that it can be installed and configured on the edge device by an installation program of the edge device.

The application software can also be a component of an application software package. Such an application software package is generally an archive, i.e., a file containing all the required files and (un-)installation routines. Execution of the archive causes an installation program to be started, which is part of an operating system of the edge device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention as well as further advantageous embodiments of the invention will now be explained in more detail in the figures using exemplary embodiments, where corresponding parts are provided with the same reference characters in each case, in which:

FIG. 1 shows an edge device in accordance with the invention;

FIG. 2 shows the edge device of FIG. 1 incorporated in a redundantly operated network using the Media Redundancy Protocol (MRP);

FIG. 3 shows the edge device of FIG. 1 incorporated in a redundantly operated network using the High-availability Seamless Redundancy Protocol (HSR);

FIG. 4 shows a flowchart of a method for providing redundancy functions according to an industrial redundancy protocol on the edge device of FIG. 1.

### DETAILED DESCRIPTION OF THE EXEMPLARY EMBODIMENTS

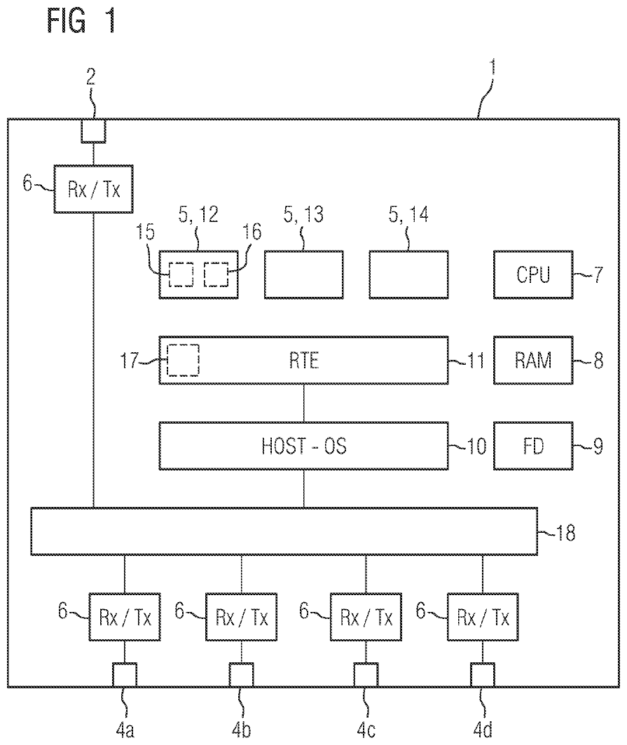

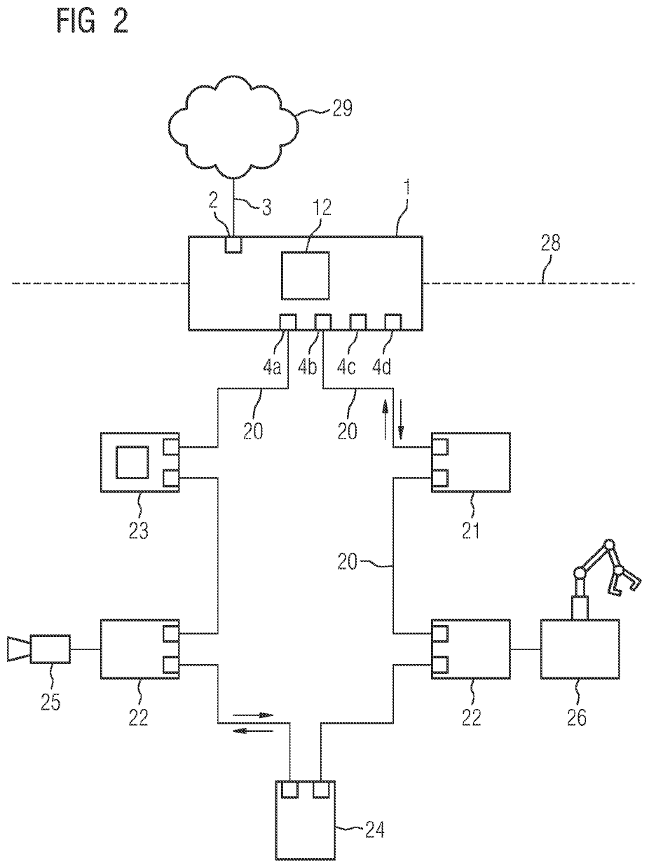

FIG. 1 shows a simplified and schematic view of an edge device 1 in accordance with the invention, comprising a first communication port 2 connected to a first network 3 (see FIG. 2), in particular a public network such as the Internet, and a plurality of second communication ports, here for example four communication ports 4a, 4b, 4c, 4d, connected to a second network 20 (see FIG. 2), in particular a private industrial network. Each of the ports 2, 4a 4b, 4c, 4d is assigned a respective transmitting and receiving unit 6.

The edge device 1 additionally comprises a processor 7 for processing program code, a main memory 8 into which the program code can be loaded, and a memory unit 9, in particular a hard disk, flash memory or SSD memory, for non-volatile storage of the program code. Installed in the edge device 1 is a host operating system 10 upon which a sequential control environment 11, for example, a Docker engine, for application software 12, 13, 14 in the form of software containers 5 is executed via the processor 7, the main memory 8 and the memory unit 9. The sequential control environment 11 uses drivers of the host operating system 10 to access a data bus 18 and the transmitting and receiving units 6, and also provides corresponding interfaces for the software containers 5 of the application software 12, 13, 14 that can be loaded into the sequential control environment 11 for execution there. The software containers 5 with the application software are each configured to execute in isolation from other software containers or container groups within the sequential control environment 11. On the other hand, the software containers 5 each share a kernel of the host operating system 10 of the edge device 1 with other software containers executing on the edge device 1.

Isolation of the software containers 5, i.e., isolation of selected operating system resources from one another, can be implemented in particular via control groups and namespacing. With control groups, process groups can be defined to restrict available resources for selected groups. Namespaces can be used to isolate or hide individual processes or control groups from other processes or control groups. Disk images for software containers can, for example, be called up from a storage and retrieval system to which a large number of users have read or write access.

The application software 12 is used to provide redundancy functions on the edge device 1 in accordance with an industrial redundancy protocol. For this purpose, the application software 12 established as a container 5 for the sequential control environment 11 (for example, a Docker engine) and can be loaded into the edge device 1 via the first port 2 (i.e., can be stored in the memory unit 9) and executed therein, for example, via the application software 13.

For this purpose, the software application 13 can comprise a special installation routine that implements storage of the application software 12 in the memory unit 9 and any necessary configuration of the application software 12.

It is particularly advantageous if the redundancy functions can be performed without needing to load further software components, i.e., operating system software, drivers, IP stack or the like, into the edge device 1 in addition to the application software 12. This is different, for example, from firmware, which typically includes further software components of this kind.

With the application software 12, the second ports 4a, 4b, 4c, 4d can be configured for redundant operation of the second network 20 in accordance with an industrial redundancy protocol, and the application software 12 is established to perform redundancy functions of the redundancy protocol.

Configuring of the second communication ports 4a, 4b, 4c, 4d is necessary, for example, in order to
assign the second communication ports (ports) 4a, 4b, 4c, 4d to a real or virtual second network (for example, interconnection or (logical) linking of two of the second communication ports to provide ring functionality),
activate a blocking function for datagrams (for example, in cases of an MRP master) or a forwarding function for datagrams (for example, in cases of an MRP client) for a second communication port, depending on the role of the edge device 1 in the redundancy protocol,
activate or deactivate monitoring of the connection status of second communication ports 4a, 4b, 4c, 4d, such as link-up monitoring or a link-down monitoring,
in principle enable or disable a second communication port 4a, 4b, 4c, 4d (for example, activate or deactivate a “Link active”).

The redundancy protocol can be, for example, the Media Redundancy Protocol (MRP) per IEC 62439-2. The application software 12 is then advantageously established such that a ring redundancy manager function or a ring redundancy client function can be performed by it, in particular selectively. Thus, a ring redundancy manager or ring redundancy client can be flexibly provided or retrofitted in the edge device 1 in accordance with the MRP protocol.

In accordance with another advantageous embodiment, the redundancy protocol is the High-availability Seamless Redundancy Protocol (HSR) or the Parallel Redundancy Protocol (PRP) per IEC 62439-3. The application software 12 is then established such that a Double Attached Node (DAN), RedBox or QuadBox function can be performed by it, in particular selectively. Thus, a Double Attached Node (DAN), a RedBox or a QuadBox can be flexibly provided or retrofitted in the edge device 1 in accordance with the HSR or PRP protocol.

The application software 12 provides, via the first port 2, a user interface 15 for logical assignment of second ports 4a, 4b, 4c, 4d by a user of the edge device 1, i.e. in order to allocate selected second ports 4a, 4b, 4c, 4d exclusively and to interlink them in a switched manner for forwarding datagrams. The user interface 15 can also provide options for selecting redundancy functions or the parameterization thereof.

The data bus 18, which is implemented in particular as a backplane switch, is configured such that interconnection of the second communication ports 4a, 4b, 4c, 4d on the data bus 18 can be configured via the application software 12.

For example, the edge device 1 or data bus 18 can have one or more registers (i.e., data stores) defining the interconnection (or linking) of second communication ports, and the application software 12 has write access to these registers to define the interconnections of the second communication ports.

In the case of the MRP protocol, both a ring redundancy manager function and a ring redundancy client function can advantageously be performed by the application software 12, and the user interface 15 is used to select one of the two functions for the performance thereof.

In the case of the HSR or PRP protocol, the application software 12 can perform a Double Attached Node (DAN), a RedBox and a QuadBox function, and the user interface 15 is used to select one of the three functions for the performance thereof.

In order to avoid malfunctions from the outset, the application software 12 advantageously also provides a test function 16 that checks whether the edge device 1 is capable of performing redundancy functions of the desired redundancy protocol. This test function can be performed, for example, during an initialization process of the application software 12. The test function is used to interrogate the hardware of the edge device 1 about the number of available second communication ports. For example, if at least two second communication ports are not available, the edge device 1 is unsuitable for performing the redundancy functions. Such an interrogation can be performed by the application software, for example, by reading registers of the edge device hardware (for example, the data bus 18 to which the second communication ports are connected).

Advantageously, the sequential control environment 11 comprises a software component 17 which, as a kind of adapter between the application software 12 and the hardware, directly accesses the second ports 4a, 4b, 4c, 4d and provides hardware resources (e.g., buffer memory for forwarding datagrams, access times, and/or interrupt line to the CPU 7) of the edge device 1 that are required to perform the redundancy functions. This can ensure good interaction between the application software 12 and the hardware of the edge device 1.

The software component 17 is advantageously configured to filter and evaluate datagrams received via the second ports 4a, 4b, 4c, 4d in accordance with the redundancy functions specified by the application software 12. This means that, when the edge device 1 is operating as an MRP redundancy manager, for example, it can ensure that the ring is in working order and perform ring failover in the event of a fault.

Other application software, such as application software 14, can provide services or functions of an industrial automation system, such as control tasks, data acquisition/data output tasks, complex calculations, evaluations of production data, archiving tasks, or can be used for secure data exchange via the public network 3 using a cloud or other automation systems.

FIG. 2 shows an example of the edge device 1 of FIG. 1 incorporated in a redundantly operated PROFINET network 20 using the Media Redundancy Protocol (MRP). Here, the ring network 20 is connected to ports 4a and 4b of the edge device 1. A plurality of communication or automation devices are connected to the network 20. These can be, for example, PROFINET-capable switches 21 or automation devices with integrated PROFINET interfaces, such as programmable logic controllers (PLCs) 22, operator control and monitoring stations 23 or I/O stations 24. In the case of FIG. 2, the programmable logic controllers (PLC) 22 are used, for example, to control equipment 25 or machines 26. An I/O station 24 is used to acquire measured values from, and to output control variables to, the equipment and machines. An operator control and monitoring station 23 is used for visualization of process data, i.e., measured variables and control variables.

One node in the network 20 must assume the role of ring redundancy manager in accordance with the MRP protocol, while all the other nodes have the role of ring redundancy client. The edge device 1 can now flexibly assume either the role of ring redundancy manager or the role of ring redundancy client.

The communication port 2 is connected to a public network 3, such as the Internet, and communicates with a cloud server (not shown in detail) in the cloud 29. The PROFINET network 20, on the other hand, is an on-site, private network. The edge device 1 is thus located at the boundary between a public area and a private area, as symbolized by the dashed dividing line 28.

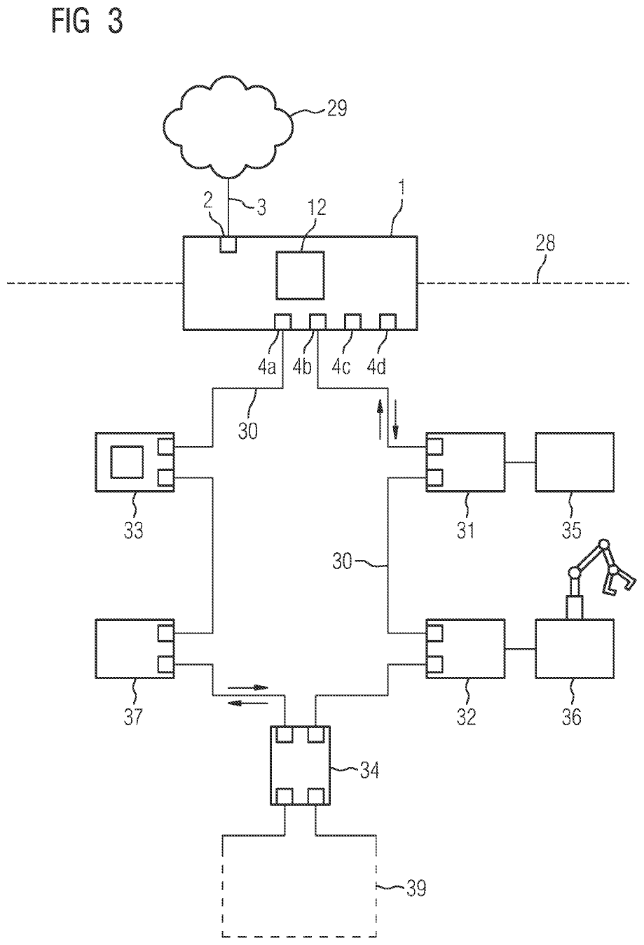

FIG. 3 shows an example of the edge device 1 of FIG. 1 incorporated in a redundantly operated Industrial Ethernet network 30 using the High-availability Seamless Redundancy protocol (HSR). Again, a ring network 30 is connected to ports 4a and 4b of the edge device 1. A plurality of communication or automation devices are connected to the network 30. These are subdivided into Double Attached Nodes (DAN), RedBoxes or QuadBoxes in accordance with IEC 62439-3 standard.

In the case of FIG. 3, the reference character 31 denotes a RedBox via which a non-HSR-capable device, here a protective device 35, for example, is connected to the network 30. A programmable logic controller (PLC) 32 for controlling a machine 36 is HSR-capable and therefore connected to the network 30 as a “Double Attached Node Implementing HSR” (DANH). Reference character 34 denotes a QuadBox that connects the HSR network 30 to another HSR network 39 and filters data traffic on the networks and forwards it to the other network. An operator control and monitoring station 33 and an I/O station 37 are HSR-capable and therefore connected to the network 30 as a “Double Attached Node implementing HSR” (DANH).

In the future, Time-Sensitive Networking (TSN) in accordance with Institute of Electrical and Electronics Engineers (IEEE) standard 802.1Q, IEEE standard 802.1AB, IEEE standard 802.1AS, IEEE standard 802.1BA and IEEE standard 802.1CB, will be increasingly used in such networks.

The application software 12 is advantageously established such that a Double Attached Node Implementing HSR (DANH) function, a RedBox function or a QuadBox function can be performed by it, in particular selectively, and the application software 12 provides the option of selecting, via the user interface 15, one of the three functions for the performance thereof.

Thus, a Double Attached Node (DANH), a RedBox, or a QuadBox can be flexibly provided or retrofitted in the edge device 1 in accordance with the HSR protocol and thus perform HSR duplicate filtering functions.

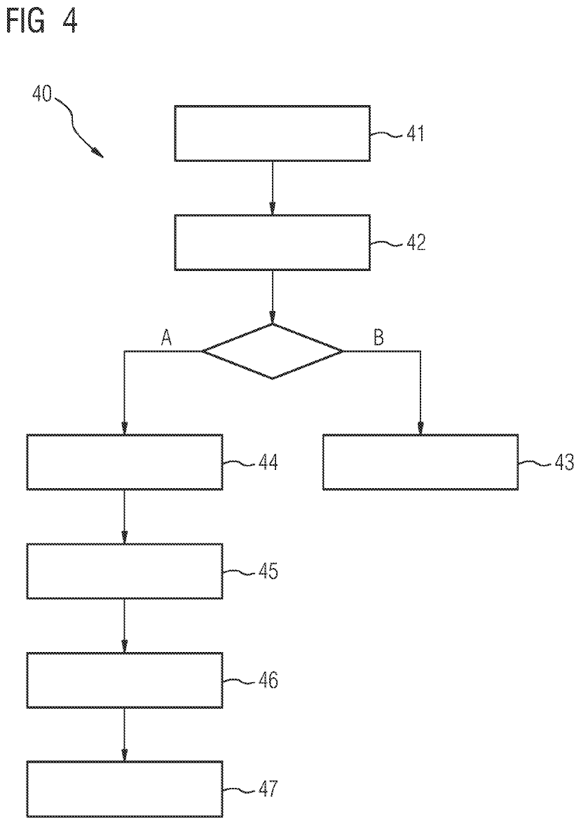

FIG. 4 illustrates a flowchart of a method 40 in accordance with the invention for providing redundancy functions on the edge device 1 of FIG. 1 in accordance with an industrial redundancy protocol.

In a first step 41, the application software 12 is loaded onto the edge device 1 via the public network 3 and the port 2 by a user via the application software 13 and a user interface provided by the latter, and is stored and executed on the device.

In a second step 42, the application software 12 now checks the hardware of the edge device 1 for suitability for executing the redundancy functions, in particular for the presence of a required number of second ports 4a, 4b, 4c, 4d, i.e., at least two ports. The check is performed here using the software component 17 of the sequential control environment 11.

Such an interrogation can be performed by the application software 12, for example, by reading registers of the hardware of the edge device 1 (for example, the data bus 18).

If the check is not successful, for example, if no two ports are available, then the method is terminated by the application software 12 in a step 43 with an error message (see path B).

If the check is successful (see path A), in a further step 44 a user is then prompted by the application software 12 via the user interface 15 for information on the configuration of the second ports, in particular the second ports selected and their logical interconnection, and to select redundancy functions (in the case of the MRP protocol, for example, whether the edge device 1 is to perform the role of ring redundancy manager or ring redundancy client).

This information is acquired by the application software 12 in a step 45, whereupon, in a step 46, the selected second ports are logically interconnected. In addition, the selected redundancy functions are set or configured in the application software 12.

For example, the edge device 1 or data bus 18 may have one or more registers (i.e., data stores) that define the interconnection (or linking) of the second communication ports, and the application software 12 has write access to these registers to define the interconnections of the second communication ports.

In a final step 47, the network 20 or 30 can then be physically connected to the selected and logically interconnected second ports.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. An edge device comprising:
a first communication port connected to a first public network;
a plurality of second communication ports connected to a second network; and
application software which is loadable into the edge device via the first communication port;
wherein the edge device is configured such that, via the application software, the plurality of second communication ports is configurable to provide redundant operation of the second network in accordance with an industrial redundancy protocol;
wherein the application software performs redundancy functions of the redundancy protocol;
wherein the edge device is configured to receive the application software via the first communication port and to execute said application software upon receipt thereof;
wherein provision of the redundancy functions is purely software-based and independent of hardware of the edge device;
wherein the application software provides a test function which checks the edge device for suitability to perform the redundancy functions of the redundancy protocol; and
wherein the application software provides a user interface for logical assignment of the plurality of second communication ports.

18. The edge device as claimed in claim 17, further comprising:
a data bus formed as a backplane switch;
wherein the plurality of second communication ports are connected to the data bus; and
wherein the data bus is configured such that an interconnection of the second communication ports on the data bus is configurable via the application software.

19. The edge device as claimed in claim 17, wherein the redundancy protocol is Media Redundancy Protocol in accordance with International Electrotechnical Commission standard 62439-2.

20. The edge device as claimed in claim 18, wherein the redundancy protocol is Media Redundancy Protocol in accordance with International Electrotechnical Commission standard 62439-2.

21. The edge device as claimed in claim 19, wherein the application software performs a ring redundancy manager function or a ring redundancy client function in accordance with the IEC 62439-2 standard.

22. The edge device as claimed in claim 17, wherein the redundancy protocol is High-availability Seamless Redundancy Protocol or Parallel Redundancy Protocol in accordance with Electrotechnical Commission standard 62439-3.

23. The edge device as claimed in claim 18, wherein the redundancy protocol is High-availability Seamless Redundancy Protocol or Parallel Redundancy Protocol in accordance with Electrotechnical Commission standard 62439-3.

24. The edge device as claimed in claim 23, wherein the application software performs a Double Attached Node, RedBox or QuadBox function in accordance with the IEC 62439-3 standard.

25. The edge device as claimed in claim 17, wherein the application software provides a user interface for selecting redundancy functions.

26. The edge device as claimed in claim 17, further comprising:
a sequential control environment configured to execute on a host operating system installed in the edge device;
wherein the application software is loadable into the sequential control environment for execution within the sequential control environment; and
wherein the sequential control environment includes an interface for accessing the plurality of second communication ports.

27. The edge device as claimed in claim 26, wherein the application software comprises at least one software container configured to execute in isolation from other software containers or container groups within the sequential control environment on the host operating system.

28. The edge device as claimed in claim 26, wherein the sequential control environment comprises a software component which directly accesses the plurality of second communication ports and provides hardware resources of the edge device which are required to perform the redundancy functions.

29. The edge device as claimed in claim 27, wherein the sequential control environment comprises a software component which directly accesses the plurality of second communication ports and provides hardware resources of the edge device which are required to perform the redundancy functions.

30. The edge device as claimed in claim 28, wherein the software component filters and evaluates datagrams received via the plurality of second communication ports.

31. A method for providing redundancy functions in accordance with an industrial redundancy protocol on an edge device comprising a first communication port connected to a first public network and a plurality of second communication ports connected to a second network, the method comprising:
a) loading application software onto the edge device via the first communication port;
b) configuring the plurality of second communication ports via the application software for redundant operation of the second network in accordance with a redundancy protocol; and
c) performing redundancy functions of the redundancy protocol by the application software;
wherein said providing the redundancy functions is purely software-based and independent of hardware of the edge device; and
wherein said step b) comprises:
performing a check, via the application software, to determine whether the hardware of the edge device is suitable to perform the redundancy functions, said method being terminated if the check is unsuccessful;
wherein if the check is successful, the method further comprising:
requesting information on the configuration of the plurality of second communication ports, the application software providing a user interface for logical assignment of second communication ports;
acquiring information on the configuration of the plurality of second configuration ports;
configuring the plurality of second communication ports; and
physically connecting the second network to the plurality of second communication ports.

32. A segment of application software, the segment of application software being established to be loaded, in cases of an edge device comprising a first communication port connected to a first public network and a plurality of second communication ports connected to a second network, via a first communication port, into the edge device and to be executed at the edge device, the application software comprising commands which, when executed, cause the edge device to perform steps b) and c) of the method as claimed in claim 31.
